(19) United States
(12) Patent Application Publication
(10) Pub. No.: US 2024/0090493 A1
(43) Pub. Date: Mar. 21, 2024

(54) ENGINEERED SIGNALS AND METHODS OF DEPLOYMENT

(71) Applicant: United States of America as Represented by The Secretary of The Army, Alexandria, VA (US)

(72) Inventor: Christa M Woodley, Vicksburg, MS (US)

(21) Appl. No.: 18/126,181

(22) Filed: Mar. 24, 2023

Related U.S. Application Data
(60) Provisional application No. 63/324,599, filed on Mar. 28, 2022.

(51) Int. Cl. A01M 29/18; G10K 15/02

(52) U.S. Cl. CPC A01M 29/18; G10K 15/02

(57) ABSTRACT

One embodiment is directed to an engineered acoustic signal for keeping an aquatic animal away from one or more specific areas. The engineered acoustic signal has deterrence stimulus evaluated to maximize effectiveness in keeping the aquatic animal away from specific areas based on at least one of: ability of the deterrence stimulus to initiate a behavioral response of the animal to keep the animal from the one or more specific areas; duration of the behavioral response; and magnitude of the behavioral response.

### CROSS-REFERENCE TO RELATED APPLICATIONS

The application is a nonprovisional of and claims the benefit of priority from U.S. Provisional Patent Application No. 63/324,599, filed on Mar. 28, 2022, entitled ENGINEERED SIGNALS AND METHODS OF DEPLOYMENT, the entire disclosure of which are incorporated herein by reference.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present invention relates to apparatus and methods of using acoustic signals to deter animals and, more specifically, to using engineered acoustic signals to reduce the spread of invasive carp species.

### Description of the Related Art

This section introduces aspects that may help facilitate a better understanding of the invention. Accordingly, the statements of this section are to be read in this light and are not to be understood as admissions about what is prior art or what is not prior art.

The United States Government through a collaboration of the United States Geological Survey and the U.S. Army Corps of Engineers recently installed an underwater acoustic deterrent system (uADS) at Lock and Dam 19, in Keokuk, Iowa, to evaluate how engineered signals may be able to reduce the spread of invasive carp species (including Asian carp). A prior study of the fish community near and in Lock and Dam No. 19 indicated that invasive carps and native fishes commonly use the lock for upstream passage. The invasive carp are considered harmful because they grow quickly and aggressively compete with native fish for food and habitat. The only continuous connection between the Great Lakes and Mississippi River basins is the Chicago Area Waterway System (CAWS) and thus it poses the greatest potential risk for the transfer of aquatic nuisance species.

Currently, and beginning with the installation of an initial electric dispersal demonstration barrier in 2002, a series of additional electric barriers have been installed in the CAWS near Romeoville, Illinois to prevent the movement of Bigheaded carps (bighead carp [Hypophthalmichthys nobilis] and silver carp [H. molitrix]), hereinafter Asian carp (AC), from the Illinois River into southern Lake Michigan. The electric barriers are one control technology in a broad interagency Asian carp prevention effort. Although the electric barrier system is considered effective as a deterrent to AC, supplemental non-structural deterrents to the electric barrier are highly desired. The use of multiple barrier technologies would likely decrease the probability that AC would move through multiple high head dams and controlled river reaches into the Great Lakes through redundancy. Increasing the number of deterrents would also create a “buffer zone,” where AC are nonexistent or in low numbers, thus providing greater confidence in their containment.

Due to the large-scale impacts in the Mississippi River Basin and associated basins, coordinated efforts have prompted research and development management tools reduce AC expansion. Significant work has been done to identify potential biological and physical techniques that are candidates for non-structural deterrents that may serve to discourage the movement of Bigheaded carps, while allowing passage of native fish, and allow for commercial shipping to continue without interference or inconvenience caused by a non-structural fish deterrent of any type. One candidate is underwater sound. Previous studies have indicated that both AC species react negatively to sound. Asian carp and other members of the superorder Ostariophysi possess a calcified connection between the inner ear and swim bladder, known as a Weberian apparatus, which enhances their hearing ability. Asian carp have a broader hearing range for freshwater fish, detecting frequencies above 3 kHz as opposed to hearing generalists which tend to be limited to frequencies of 50 Hz to 1 kHz, at relatively high sound intensities (greater than 80 dB re 1 μPa). This hearing range may allow for selectively deterring invasive carps, with few impacts to non-target species. Prior studies have indicated that the bigheaded carp (Hypophthalmichthys spp.) will repeatedly respond to complex sound, such as 100 Hp boat motor engine, while many native fish respond little to the signal. In addition to low environment and ecological impacts, underwater acoustics deterrents are minimal risk for humans and navigation safety, and have low costs for installations, and long-term operations and maintenance (O&M).

### SUMMARY

The present invention was developed to address the desire for a long-term underwater acoustic deterrent system for use in a riverine system. Multiple factors are considered in achieving effective long-term acoustic deterrents. The use of sound frequencies (Hz), sound pressure levels (SPL, dB re 1 μPa), and speaker design and placement to repel Asian Carp (AC) while preventing injury to native aquatic species are desirable. Also desirable is the determination of the efficacy of acoustic deterrents to contain, herd, and capture AC. For both these elements, it is desirable to assess these acoustic deterrents in the field on motivated fish (spawning, feeding, etc.). Moreover, there is a need to critically evaluate the efficacy of underwater acoustic deterrent technology when deployed on a large scale, such evaluation of the underwater acoustic deterrent to continue over time and as the work broadens in scope (reevaluation), and re-deployment and further testing in new environments or locations, as necessary. Finally, it is further desirable to develop tools that predict movement based on Lock & Dam operations and long-term remote monitoring of fish and acoustic deterrent systems.

An aspect the present invention is directed to an engineered acoustic signal for keeping an animal away from one or more specific areas. The engineered acoustic signal has deterrence stimulus evaluated to maximize effectiveness in keeping animals away from specific areas based on at least one of: ability of the deterrence stimulus to initiate a behavioral response of the animal to keep the animal from the one or more specific areas; duration of the behavioral response; and magnitude of the behavioral response.

In some embodiments, evaluating the deterrence stimulus of the engineered acoustic signal to maximize effectiveness comprises deploying the deterrent acoustic array or engineered acoustic signal in an aquatic environment to deter Asian carp; and observing the behavioral response of the Asian carp which comprises experimentally observing presence or absence of at least one of the following response factors: rapid onset of sound; irregular patterns of sound; sound that increases in amplitude of a frequency range; sound that does not decrease in frequency or loudness; sound that is greater than 140 dB re 1 μPa; and sounds that overlap with the Asian carp's hearing range, which tend to create stronger behavioral responses of the Asian carp.

In specific embodiments, the engineered acoustic signal is masked by navigation noise. Evaluating the deterrence stimulus of the engineered acoustic signal to maximize effectiveness comprises determining an appropriate frequency range in which to increase the engineered acoustic signal so as to deter the animal despite the presence of navigation noise.

Another aspect of the invention is directed to a method of deploying an engineered acoustic signal for keeping an animal away from one or more specific areas. The method comprises evaluating the engineered acoustic signal having deterrence stimulus to maximize effectiveness in keeping animals away from specific areas based on at least one of: ability of the deterrence stimulus to initiate a behavioral response of the animal to keep the animal from the one or more specific areas; duration of the behavioral response; and magnitude of the behavioral response.

In some embodiments, the method further comprises deploying the engineered acoustic signal, which is audible to a certain or all species of invasive carp, in an aquatic environment to deter invasive carp. The method may further comprise producing a Doppler like-effect of sound approaching the animal using the engineered acoustic signal.

In specific embodiments, the method further comprises deploying the designed deterrent acoustic array in a Lock & Dam and modifying the designed deterrent acoustic array or engineered acoustic signal which includes: measuring an output of sound projector array elements of the designed deterrent acoustic array and interaction between the sound projector array elements; measuring ambient levels of sound in an approach channel of the Lock & Dam; measuring sound propagation in the approach channel of the Lock and Dam; determining appropriate classes of one or more propagation models to use at the Lock & Dam; and developing an acoustic propagation model for the approach channel of the Lock & Dam that best predicted the measured output, and the measured ambient levels, the sound propagation in the approach channel. The method further comprises redeploying the modified engineered acoustic signal in the Lock & Dam using the developed acoustic propagation model.

In some embodiments, the method further comprises observing a quantitative measure of deterrence as a distance travelled of how far an invasive carp will continue to travel while maintaining a prior direction of travel before encountering the designed deterrent acoustic array or engineered acoustic signal, when subjected to the designed deterrent acoustic array or engineered acoustic signal; and modifying the designed deterrent acoustic array or engineered acoustic signal until the distance travelled is 20,000 cm or less.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 illustrates an example of a 100 hp signal.

FIG. 2 illustrates an example of a long-term spectra for a Lock & Dam configuration.

FIG. 3 illustrates an example of ambient noise generated by navigation.

FIG. 4 illustrates an example of field engineered test tones used for examining the function of a transducer (hydrophone or speaker) across a frequency pattern and developing a baseline of sound as it propagates through an area.

FIG. 5 illustrates an example of a graph of sound pressure level as a function of frequency illustrating human hearing thresholds in air and in water. http://resource.npl.co.uk/docs/science_technology/acoustics/clubs groups/13oct05_seminar/par vin_subacoustech.pdf.

FIG. 6 shows an example of a diagram illustrating acoustic deterrent design with representative biology.

FIG. 7 shows an example of an audiogram and particle acceleration thresholds for bighead carp, silver carp, common carp. doi: 10.1371/journal.pone.0192561.eCollection 2018.

FIG. 8 shows an example of a diagram illustrating acoustic deterrent design with representative environmental sound.

FIG. 9 shows an example of a diagram illustrating acoustic deterrent design with representative anthropogenic sound.

FIG. 10 shows an example of an engineered acoustic signal having a sawtooth waveform as a result of the present research.

FIG. 11 shows an example of an engineered acoustic signal having a square waveform as a result of the present research.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Embodiments of the present invention provide long-term underwater acoustic deterrent system and method to repel invasive carp including Invasive Carp (AC) while reducing or preventing injury to native aquatic species. Research has been conducted to determine the efficacy of acoustic deterrents to contain, herd, and capture AC. The research critically evaluates the efficacy of underwater acoustic deterrent technology when deployed on a large scale. The research has led to embodiments of engineered acoustic signal which provide an effective deterrence for repelling AC. The mechanism of deployment may be an underwater sound transmission and amplification apparatus.

### Development of an Acoustic Propagation Model

An important initial step in the process of deploying engineered signals into an aquatic environment is the development of an acoustic propagation model suitable for, e.g., a particular Lock & Dam. Such a propagation model may be used for similarly designed locks, with modifications, to effect re-deployment of engineered signals in additional locations and minimize future efforts and associated cost in Lock sound propagation characterization. To this end, in developing the systems and methods of generating and deploying engineered signals into an aquatic environment: (i) the output of the sound projector array elements and interaction between elements are measured; (ii) the ambient levels of sound in the approach channel of the subject Lock & Dam are measured; (iii) the sound propagation in subject Lock and Dam approach channel is measured; (iv) a determination of the appropriate classes of propagation model(s) to use at the subject Lock & Dam is completed; and (v) an acoustic propagation model is developed for the subject Lock & Dam approach channel using the model that best predicted the collected data.

Projector performance testing is conducted to ensure that all equipment (cables, connectors, speakers, amplifiers) meet vendor specifications. Projectors are designed to produce sound within specified frequency bands at a minimum and maximum loudness (dB re 1 μPa). Matching the sound producing capabilities of the projectors to the desired sounds and propagation of those sounds in the desired location is paramount to success of the sound production system. The system produces the required sound levels in the needed frequency bands with acceptable power consumption and functional lifetime. In addition, beam pattern forming from the speakers are measured to examine and evaluate any distance needed between speakers to reduce transmission losses. When sounds combine, the phase of the sound is important. In phase, sounds add constructively; out of phase they add destructively, forming a beam. By adjusting the phase, beams can be steered. Sound waves interact with their environment, so consideration is given to distance from a sound source. Small distances from the sound source have low or no interaction, while conical spreading loss occurs at greater ranges in shallow water systems. Reflected sound rays interact in a similar fashion to surface water waves reflecting from a pool wall. The Lock & Dam environment may comprise cement on three sides and water on the fourth side. Accordingly, the approach lock becomes a highly reflective domain which may lead to increased transmission loss. Projector array and engineered signal designs implicate interference patterns from the beam forming sources and should be taken into consideration for a particular engineered channel configuration. Additional projector array design considerations are ambient noise, native and invasive fish hearing, coverage, obstructions, and sound profiles & sound levels.

It may be desirable in evaluating and designing a particular array for a specific Lock & Dam location to add an additional vessel and swivel arms on each vessel to accommodate navigation thereby having mobile sound and playback vessels, as opposed to having one vessel recording sound from the lock doors down the channel. Various fixed sound receiver locations may be selected where ambient and playback sounds (e.g., engineered tones) are monitored, e.g., over a 7-day period; and as stated using 2 vessels, 2 projectors, and several hydrophones may be placed on the vessel and along the channel to capture sound in 3D and particle motion. Multiple source locations are desirable (e.g., 10-15 source locations) or in certain embodiments of the invention, 12 source locations may be used.

A 3D Parabolic Model with range-dependent parameters (i.e., sediment characteristics, bathymetry) and out-of-plane reflections may be used to model transmission loss at a Lock & Dam location. Decibel loss (dB)—that is transmission loss (TL)—is largely if not entirely due to the reflective surfaces in the Lock & Dam environment. Study of this phenomena in connection with developing an acoustic model in accordance with embodiments of the invention shows that such loss is greater at 3500 Hz when compared to 500 Hz because of the refraction of sound and shorter wavelength at 3500 Hz.

Many configurations are possible with respect to the manner in which engineered signals may be deployed in a Lock & Dam environment. In embodiments of the invention, there may be a first speaker array comprising 2 rows having speakers spaced 10′ apart and rows spaced 20′ apart. In further embodiments of the invention a second speaker array may comprise 12 speaker rows having speakers spaced 10′ apart and rows spaced 20′ apart. The number of speakers may be reduced without impacting coverage in embodiments of the invention by using engineered signals that have limited frequency and amplitude range, and speakers may be redesigned to increase amplitude and ability to spread sound. In embodiments of the invention speaker arrays may be designed to provide coverage to a mix of walls and floor surfaces.

Development of test tones for a particular Lock & Dam Sound propagation model may include using a signal that covers the hearing range of Invasive carp (0 Hz to 8000 Hz) and overlapped with the 100 Hp playback.

### Examination of 100 HP Outboard Motor Playback

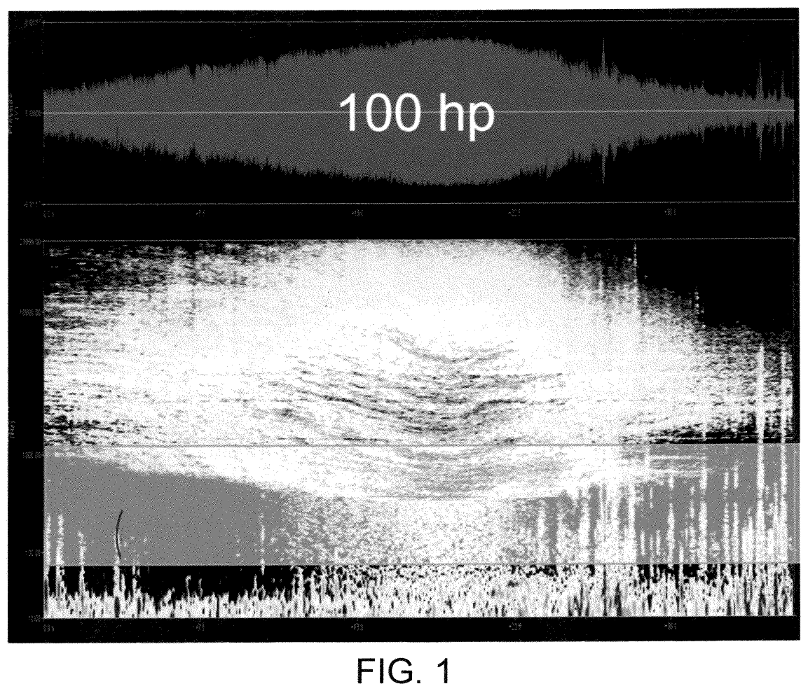

FIG. 1 illustrates an example of a 100 hp signal. The use of a 100 hp outboard motor (e.g., 100 hp Yamaha 4-stroke) and boat travelling 32 km/hr past an HTI-96-min hydrophone at a nearest distance of 10 m playback sound has been investigated by Murchy et al. 2016 & 2017 and Vetter et al. 2016, 2017, and 2018. See, e.g., Vetter, Brooke J., and Alien F. Mensinger. “Broadband sound can induce jumping behavior in invasive silver carp (Hypophthalmichthys molitrix).” Proceedings of Meetings on Acoustics 4ENAL. Vol. 27. No. 1. Acoustical Society of America, 2016; Brooke J. Vetter, Kelsie A. Murchy, Aaron R. Cup, Jon J. Amberg, Mark P. Gaikowski, and Allen Mensinger, “Acoustic Deterrence of Bighead Carp (Hypophthalmichthys Nobilis) to a Broadband Sound Stimulus,” Journal of Great Lakes Research, Vol. 43, Issue No. 1, pages 163-171, doi: 10.1016/j.jglr.2016.11.009 (1 Feb. 2017); Vetter, Brooke J., Robin D, Calfee, and Allen F. Mensinger. “Management implications of broadband sound in modulating wild silver carp (Hypophthalmichthys molitrix) behavior.” Management of Biological Invasions 8.3 (2017): 371-376, doi.org/10.33911mbi.2017.8.3.10; K. A. Murchy, A. R. Cupp, J. J. Amberg, B. J. Vetter, K. T. Fredricks, M. P. Gaikowski, and A. F. Mensinger, “Potential Implications of Acoustic Stimuli as a Non-Physical Barrier to Silver Carp and Bighead Carp,” doi.org/10.1111/fme.12220 (22 May 2017); and Kelsie A. Murchy, Brooke J. Vetter, Marybeth K. Brey, Jon. J. Amberg, Mark P. Gaikowski, and Allen F. Mensinger, “Not All Carps are Created Equal: Impacts of Broadband Sound on Common Carp Swimming Behavior,” Proceedings of Meetings on Acoustics, Vol. 27, 010032, pages 1-9 (2017), Fourth International Conference on the Effects of Noise on Aquatic Life, Dublin, Ireland (10-16 Jul. 2016) doi.org/10.1121/2.0000314; Vetter, Brooke J., Marybeth K. Brey, and Allen F. Mensinger. “Reexamining the frequency range of hearing in silver (Hypophthalmichthys molitrix) and bighead (H. nobilis) carp.” PLoS One 13.3 (2018): e0192561.

The characterization is 35 s in duration, frequency range of 10 Hz to 23,999 Hz, an amplitude that increases from 0.15V to 1V and returns to 0.18V, asymmetric between two channels, and the second channel has a digital signature of filtration. As may be studied in connection with long-term ambient spectra, a majority of energy in over a 7-day period at a selected Lock & Dam may be between 60 and 1000 Hz. This includes the ambient noise generated by water movement around the hydrophone (e.g., splashing), local biologically produced sounds, and nearby transportation noise. The majority of power (dB re 1 μPa) of the 100 hp signal is in the frequency range (100-1000 Hz) which overlaps with most native and non-native species hearing sensitivities. In addition, the noise produced by some commercial vessels commonly using lock approaches also has the greatest power in the (10-1000 Hz). It would be desirable to produce signals where the majority of the sound wave (time per frequency) was outside of this frequency range, or with specific patterns within it, so that any generated engineered signal does not have to be “louder” than navigation, i.e., a commercial tow. The loudest section of the 100 hp playback signal would be masked by passing tows (based on long-term spectra for the selected Lock & Dam configuration).

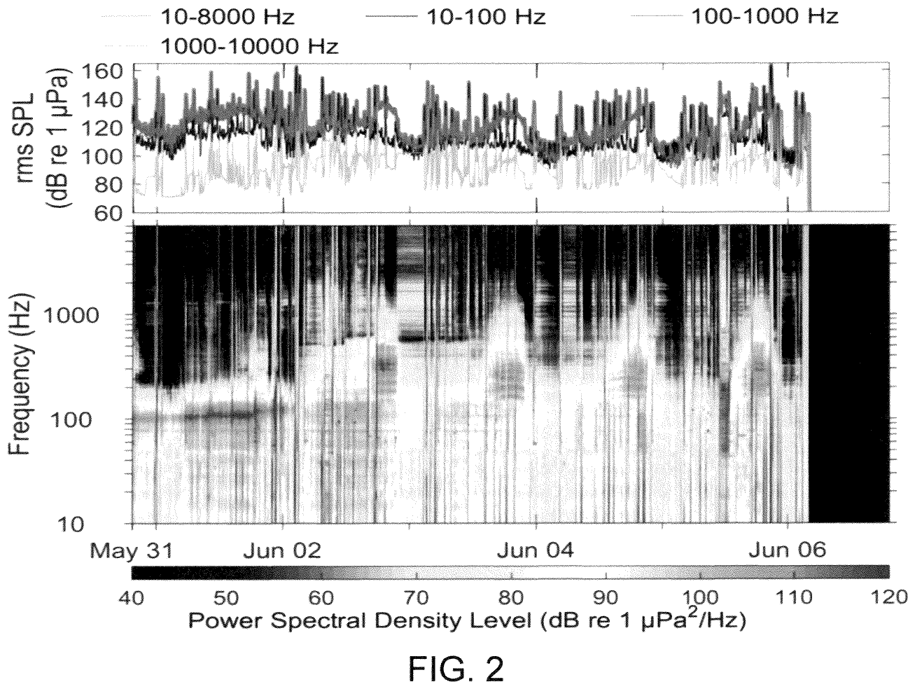

FIG. 2 illustrates an example of a long-term spectra for a Lock & Dam configuration. This is considered not to be an optimal result. An object of the invention is for any deployed engineered signal to create a deterrence for invasive carp. In the instance where the loudest portion of the 100 hp playback (or any proposed sound or engineered sound) is masked by navigation sounds or noises of a tow, it is believed that AC deterrence would be negatively impacted as tows are passing over the acoustics array, a common occurrence in many (if not all) proposed Lock & Dam locations.

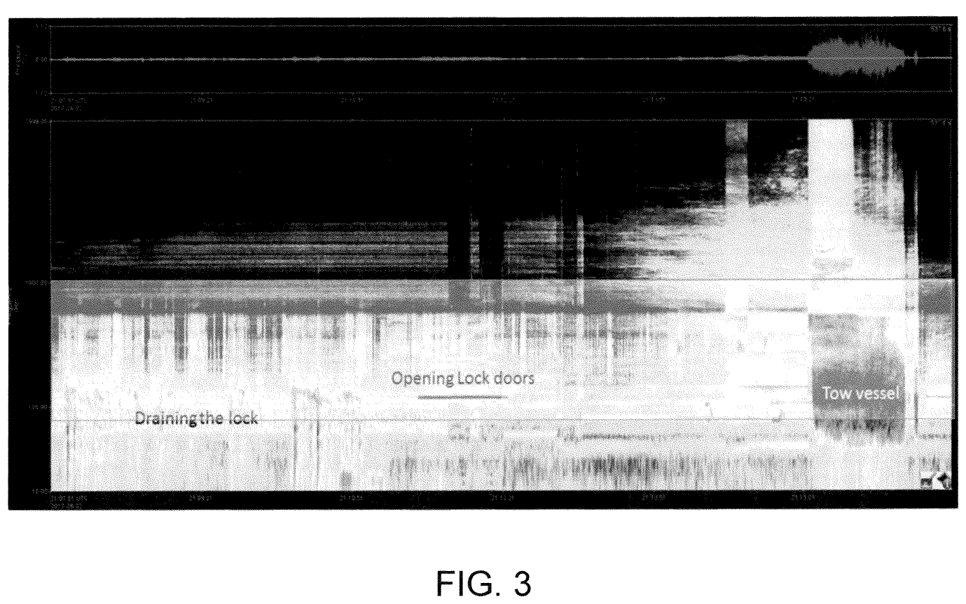

This research includes analysis of ambient noise generated by navigation. As may be shown in a detailed study of sound generated by navigation at a Lock & Dam location, the main sound generation elements (opening lock doors, draining the lock, tow vessel noise) have a majority of energy (loudness; dB re 1 μPa) in the 100-1000 Hz range (x-axis). FIG. 3 illustrates an example of ambient noise generated by navigation.

### Development of Novel Engineered Signals to Deter Invasive Carp

Knowing the range and thresholds of invasive carp hearing is critical to define “effective” sound playbacks that will elicit behavioral responses for the acoustic deterrent array. Phonotaxis (movement of an organism in relation to a sound source) is response that implies the sound used to elicit the response was within the hearing range of the fish. The lack of phonotaxis, however, does not mean that the fish could not hear the cue. Not all acoustic cues will initiate a behavioral response, and some may initiate a range of responses from subtle movements that are transient to more intense movements. Salient movements and movement patterns provide spatio-temporal information needed to design deterrent arrays and maximize their effectiveness in keeping animals away from specific areas. Three elements are critical when evaluating deterrence stimuli: 1) the ability of the stimulus to initiate a behavioral response, 2) the duration of the behavioral response, and 3) the magnitude on the behavioral response.

Informing the invention of engineered signals to deploy in aquatic environments to deter invasive carp included several experimentally observed response factors: Bighead carp respond to (1) rapid onset of sound, (2) irregular patterns of sound, (3) sound that increases in amplitude of a frequency range, (4) sound that does not decrease in frequency or loudness, (5) sound that is greater than 140 dB, and (6) sounds that overlap in the upper and lower ends of their hearing which tend to create stronger responses. Also, other inventive factors are contemplated in the discovery of engineered signals effective to deter Invasive Carp (IC). While certain sounds may initially appear to be promising, there may be a queue for the IC to return back to normal behavior by which is meant they are ultimately not deterred.

The evaluation of the specific hearing range of the individual IC species (in other words, what engineered signals are audible to a certain or all species of invasive carp to be deterred) is a factor, i.e., certain sounds may be more effective to deter certain species of invasive carp due to their hearing range or other undetermined factors.

Further, if effective sounds are discovered but are masked by navigation sounds or noises, as discussed above, it may be possible to create an engineered signal that is increased in decibels in the appropriate frequency range such that it may still act so as to deter the invasive carp. Attention is given to the possibility that invasive carp may habituate or “adapt” to the navigation background noise patterns present in the given environment.

It has been unexpectedly discovered that invasive carp may be susceptible to the Doppler like-effect, wherein if the sound is perceived to be approaching the invasive carp may be deterred, but a sound that is perceived as receding or increasing in distance from the fish may not be perceived as a threat and therefore not an effective deterrent or not as effective as approaching sound. “Doppler-like effect” is described as a noticeable gain and drop of pitch as noise as it approaches and passes by the subject or the carp.

While some studies of the 100 hp outboard motor have included as a part of the recorded sound pattern of splashing originating in all probability from wave action on the recording platform or raft, water lapping and splashing noises are not a component of the engineered signals in accordance with the invention. The primarily reason for exclusion is that when invasive carp forage, they may “roll” on the surface of the water, creating water lapping or splashing sounds. Water lapping, and splashing, then, could scare fish but it also could excite fish thus resulting in a misinterpretation of the engineered signal intent.

A quantitative measure of deterrence has been developed called “distance travelled” and measured in units of length, e.g., cm. It is an indication of how far an invasive carp will continue to travel when subjected to a sound. The 100 hp outboard motor sound pattern believed to be somewhat effective and studied, as indicated and discussed above, has a rejection rate of 110,000 cm which includes fish behavior where fish do not reverse direction and may even return to their prior direction of travel.

In a surprising and unexpected discovery, the engineered signals according to embodiments of the present invention have a dramatically improved distance travelled of 20,000 cm or less, which is over five times better than the 100 hp outboard motor sound pattern. Additionally, the observed behaviors of the fish when subjected to the engineered signals in accordance with embodiments of the invention include possible reversal of direction, freezing, or seeking shelter.

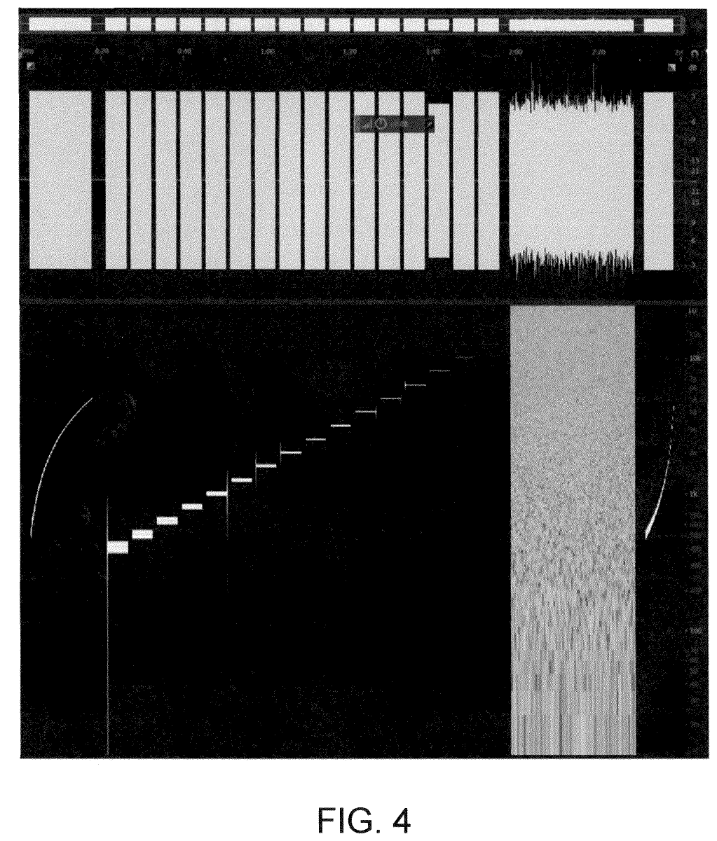

FIG. 4 illustrates an example of field engineered test tones used for examining the function of a transducer (hydrophone or speaker) across a frequency pattern and developing a baseline of sound as it propagates through an area. The pure tones cover a broad frequency band range, while maintaining a relative loudness (dB). The upper graph provides voltage of the signal (y-axis) of the time of the signal (x-axis). The lower graph shows the pure tones in Hz (y-axis), time (x-axis), and the color intensity a voltage correlated to the upper graph.

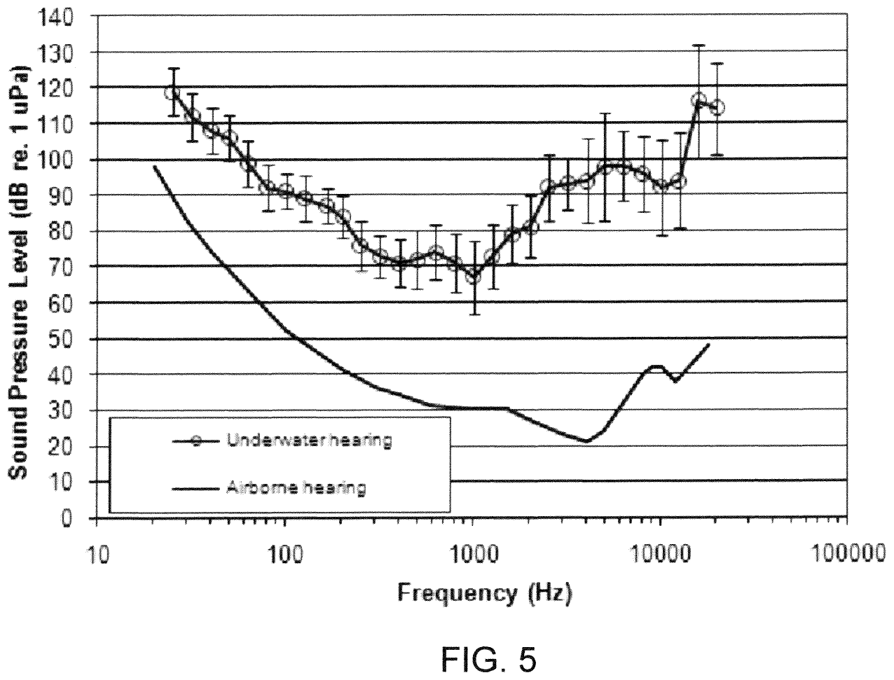

FIG. 5 illustrates an example of a graph of sound pressure level as a function of frequency illustrating human hearing thresholds in air and in water. http://resource.npl.co.uk/docs/science_technology/acoustics/clubs groups/13oct05 seminar/par vin_subacoustech.pdf. The graph shows comparison of human Minimum Audible Field (MAF) airborne and underwater hearing threshold. See S J Parvin and J R Nedwell, “Underwater Sound Perception and the Development of an Underwater Noise Weighting Scale,” Underwater Technology, Vol. 21, No. 1, pages 12-19 (1995), oi.org/10.3723/175605495783328836; S J Parvin, E A Cudahy, and D M Fothergill, “Guidance for diver exposure to underwater sound in the frequency range from 500 to 2500 Hz,” Proceedings of Undersea Defense Technology, La Spezia, Italy (2002).

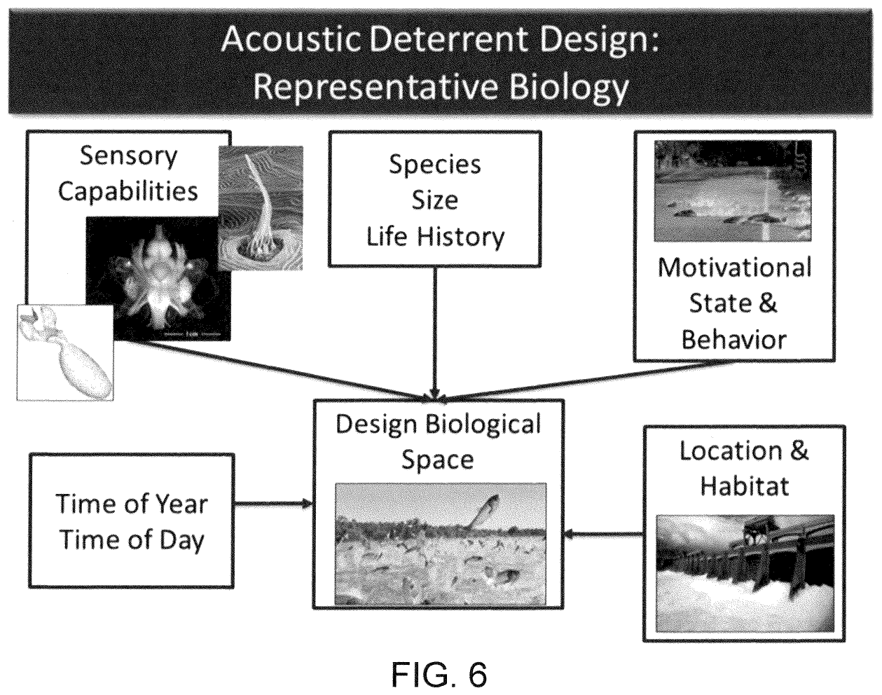

FIG. 6 shows an example of a diagram illustrating acoustic deterrent design with representative biology. It describes underwater animals' behavior in relation to environmental acoustics. To understand underwater animals' behavioral responses to environmental acoustics, one assumes that all responses are dependent upon several factors including, for example, prior exposure (habituation vs. sensitization) to the stimuli, location & habitat, sensor capabilities, current sound exposure level/sound pressure levels, motivational state at time of exposure (i.e., spawning, hunger, injury, illness, etc.), and species size & life history (age, gender, and health). Using criteria of this nature allows one to design a representative biological space that represents a percentage of a family or species population of interest that is likely to respond to a noise as a statistical quantity due to a full range of behavioral and contextual variables.

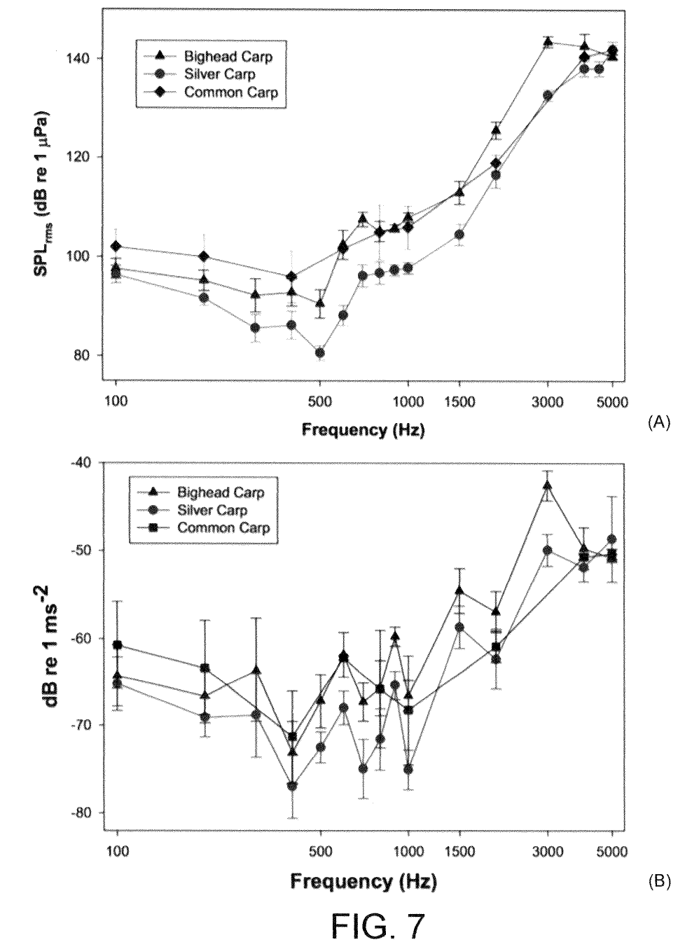

FIG. 7 shows an example of an audiogram and particle acceleration thresholds for bighead carp, silver carp, common carp. doi: 10.1371/journal.pone.0192561. eCollection 2018. In view (A), each data point represents the minimum SPL_{RMS} (dB re 1 μPa) necessary to invoke an AEP (Auditory Evoked Potential) response at each frequency examined (100 Hz-5 kHz). Data are reported as mean (±SD). See Brooke J. Vetter, Kelsie A. Murchy, Aaron R. Cup, Jon J. Amberg, Mark P. Gaikowski, and Allen Mensinger, “Acoustic Deterrence of Bighead Carp (Hypophthalmichthys nobilis) to a Broadband Sound Stimulus,” Journal of Great Lakes Research, Vol. 43, Issue No. 1, pages 163-171, 10.1016/j.jglr.2016.11.009 (1 Feb. 2017). In view (B), shows the particle acceleration thresholds (dB re 1 ms⁻²) for the bighead, silver, and common carp. Each threshold was derived using a tri-axial accelerometer and are reported as the combined magnitude vector of the x, y, and z-axes Data are reported as mean (±SD).

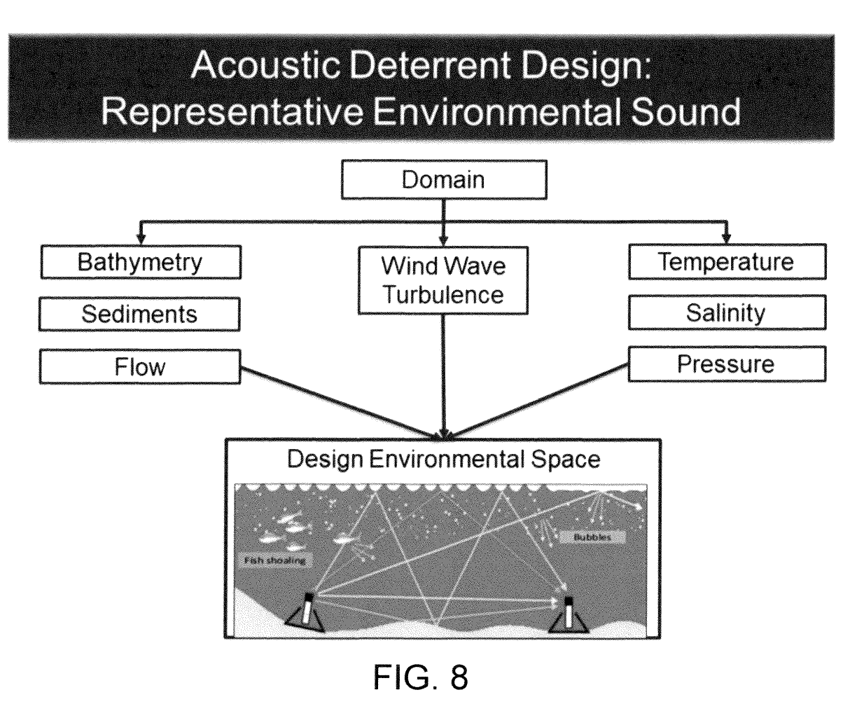

FIG. 8 shows an example of a diagram illustrating acoustic deterrent design with representative environmental sound. It describes environmental sound relative to the area of interest. Several pieces of environmental information are desirable input to design an acoustic array for a lock approach channel: bathymetry, benthos characterization, sediments, flow, wind wave turbulence, temperature, pressure, and salinity. To describe the acoustics of an area of interest, the collection of the ambient soundscape is needed—that is, representative samples of naturally occurring and anthropogenic noise. The soundscape should take into consideration sound variation at night, sources of noise, variation within those sources—essentially, any normally expected noise in the region.

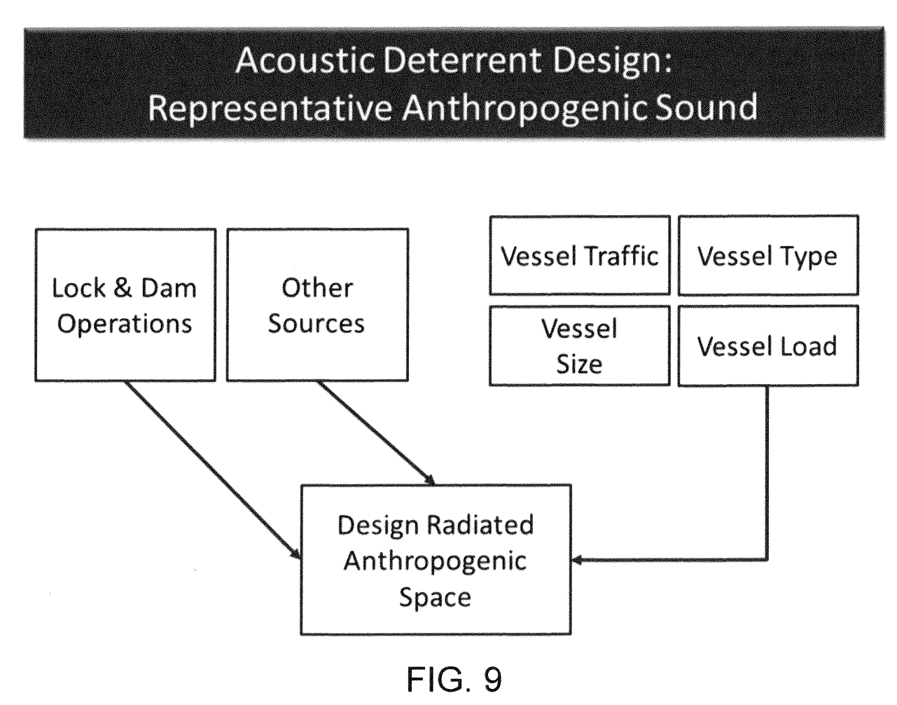

FIG. 9 shows an example of a diagram illustrating acoustic deterrent design with representative anthropogenic sound. It describes anthropogenetic noise. In many study areas, the ambient sound or soundscape now includes that of anthropogenic generated noise. For a selected Lock and Dam, noise generated would include size of vessels, vessel loads, size of barges, barge loads, size of tow, where within the region the tow engine rpms (e.g., acceleration, deceleration, idling), local sources of noise including recreational vessels, trains, planes, bridges, vehicle traffic, vessels, vessel load, lock and dam operations, etc.—essentially, any normally expected noise in the area of interest generated from non-biological sources.

Description of Signal 1. Chirp Sawtooth 20 Hz 2000 Hz 02a 08a Lin LP 5000 Hz. This signal is a 3.36 MB uncompressed .wav file. The signal is designed as a mono signal that is 20 seconds long with a sample rate of 44100 Hz and a 32-bit float depth. The signal is based on a sawtooth waveform, where the parameters set were 20 HZ, 2000 Hz, Linear progress, Low Pass filter at 5000 Hz, and silenced over 7 kHz. The peak amplitude is −2.20 dB re 20 μPa and total RMS amplitude is −8.05 dB re 20 μPa. The silencing preserves the speaker from placing energy into ranges that are not needed due to fish hearing limitations. The 5000-7000 Hz remained because as sound refracts and changes, this would preserve a buffer zone that may affect the carp hearing. The limitation of the public domain audiograms is that based on research convection that audiogram stopped at 5000 Hz, which may or may not mean that the fish had capacity to hear up to 7000 Hz at greater than 140 dB re 1 μPa. In another embodiment, the peak amplitude is 70.8 dB Pa and total RMS amplitude is 58.6 dB Pa instead.

Description of Signal 2. Chirp Sawtooth 20 Hz 2000 Hz 02a 08a Log LP 5000 Hz. This signal is a 3.36 MB uncompressed .wav file. The signal is designed as a mono signal that is 20 seconds long with a sample rate of 44100 Hz and a 32-bit float depth. The signal is based on a sawtooth waveform, where the parameters set were 20 HZ, 2000 Hz, Logarithmic progress, Low Pass filter at 5000 Hz, and silenced over 7 kHz. The peak amplitude is −1.62 dB re 20 μPa and total RMS amplitude is −7.67 dB re 20 μPa. The silencing preserves the speaker from placing energy into ranges that are not needed due to fish hearing limitations. The 5000-7000 Hz remained because as sound refracts and changes, this would preserve a buffer zone that may affect the carp hearing. The limitation of the public domain audiograms is that based on research convection that audiogram stopped at 5000 Hz, which may or may not mean that the fish had capacity to hear up to 7000 Hz at greater than 140 dB re 1 μPa. In another embodiment, the peak amplitude is 72.3 dB Pa and total RMS amplitude is 59 dB Pa instead.

Description of Signal 3. Chirp Sine 20 Hz 2000 Hz 02a 08a Lin LP 5000 Hz. This signal is a 3.36 MB uncompressed .wav file. The signal is designed as a mono signal that is 20 seconds long with a sample rate of 44100 Hz and a 32-bit float depth. The signal is based on a sine waveform, where the parameters set were 20 HZ, 2000 Hz, Linear progress, Low Pass filter at 5000 Hz, and silenced over 7 kHz. The peak amplitude is −1.69 dB re 20 μPa and total RMS amplitude is −5.53 dB re 20 μPa. The silencing preserves the speaker from placing energy into ranges that are not needed due to fish hearing limitations. The 5000-7000 Hz remained since as sound refracts and changes, this would preserve a buffer zone that may affect the carp hearing. The limitation of the public domain audiograms is that based on research convection that audiogram stopped at 5000 Hz, which may or may not mean that the fish had capacity to hear up to 7000 Hz at greater than 140 dB re 1 μPa. In another embodiment, the peak amplitude is 74.5 dB Pa and total RMS amplitude is 61.2 dB Pa instead.

Description of Signal 4. Chirp Sine 20 Hz 2000 Hz 02a 08a Log LP 5000 Hz. This signal is a 3.36 MB uncompressed .wav file. The signal is designed as a mono signal that is 20 seconds long with a sample rate 44100 Hz and a 32-bit float depth. The signal is based on a sine waveform, where the parameters set were 20 HZ, 2000 Hz, Logarithmic progress, Low Pass filter at 5000 Hz, and silenced over 7 kHz. The peak amplitude is −1.69 dB re 20 μPa and total RMS amplitude is −5.53 dB re 20 μPa. The silencing preserves the speaker from placing energy into ranges that are not needed due to fish hearing limitations. The 5000-7000 Hz remained since as sound refracts and changes, this would preserve a buffer zone that may affect the carp hearing. The limitation of the public domain audiograms is that based on research convection that audiogram stopped at 5000 Hz, which may or may not mean that the fish had capacity to hear up to 7000 Hz at greater than 140 dB re 1 μPa. In another embodiment, the peak amplitude is 74.5 dB Pa and total RMS amplitude is 61.2 dB Pa instead.

Description of Signal 5. Chirp Square 20 Hz 2000 Hz 02a 08a Log LP 5000 Hz. This signal is a 3.36 MB uncompressed .wav file. The signal is designed as a mono signal that is 20 seconds long with a sample rate 44100 Hz and a 32-bit float depth. The signal is based on a square waveform, where the parameters set were 20 HZ, 2000 Hz, Logarithmic progress, Low Pass filter at 5000 Hz, and silenced over 7 kHz. The peak amplitude is 0.84 dB re 20 μPa and total RMS amplitude is −2.78 dB re 20 μPa. The silencing preserves the speaker from placing energy into ranges that are not needed due to fish hearing limitations. The 5000-7000 Hz remained since as sound refracts and changes, this would preserve a buffer zone that may affect the carp hearing. The limitation of the public domain audiograms is that based on research convection that audiogram stopped at 5000 Hz, which may or may not mean that the fish had capacity to hear up to 7000 Hz at greater than 140 dB re 1 μPa. In another embodiment, the peak amplitude is 77.7 dB Pa and total RMS amplitude is 63.9 dB Pa.

Description of Signal 6. Chirp Square 20 Hz 4000 Hz 02a 08a Lin 20 s LP 6000 Hz. This signal is a 3.36 MB uncompressed .wav file. The signal is designed as a mono signal that is 20 seconds long with sample rate of 44100 Hz and a 32-bit float depth. The signal is based on a square waveform, where the parameters set were 20 HZ, 4000 Hz, Logarithmic progress, Low Pass filter at 6000 Hz, and silenced over 7 kHz. The peak amplitude is 7.82 dB re 20 μPa and total RMS amplitude is 2.84 dB re 20 μPa. The silencing preserves the speaker from placing energy into ranges that are not needed due to fish hearing limitations. The 6000-7000 Hz remained since as sound refracts and changes, this would preserve a buffer zone that may affect the carp hearing. The limitation of the public domain audiograms is that based on research convection that audiogram stopped at 5000 Hz, which may or may not mean that the fish had capacity to hear up to 7000 Hz at greater than 140 dB re 1 μPa. In another embodiment, the peak amplitude is 84.7 dB Pa and total RMS amplitude is 69.5 dB Pa.

Description of Signal 7. Chirp Square No Alias 20 Hz 2000 Hz 02a 08a Log 20 s LP 6000 Hz. This signal is a 3.36 MB uncompressed .wav file. The signal is designed as a mono signal that is 20 seconds long with a sample rate of 44100 Hz and a 32-bit float depth. The signal is based on a square waveform, where the parameters set were 20 HZ, 2000 Hz, Logarithmic progress, Low Pass filter at 6000 Hz, silenced over 7 kHz, and aliasing removed. The peak amplitude is 8.12 dB and total RMS amplitude is 8.07 dB. The silencing preserves the speaker from placing energy into ranges that are not needed due to fish hearing limitations. The 6000-7000 Hz remained since as sound refracts and changes, this would preserve a buffer zone that may affect the carp hearing. The limitation of the public domain audiograms is that based on research convection that audiogram stopped at 5000 Hz, which may or may not mean that the fish had capacity to hear up to 7000 Hz at greater than 140 dB re 1 μPa. In another embodiment, the peak amplitude is 84.7 dB Pa and total RMS amplitude is 71.6 dB Pa.

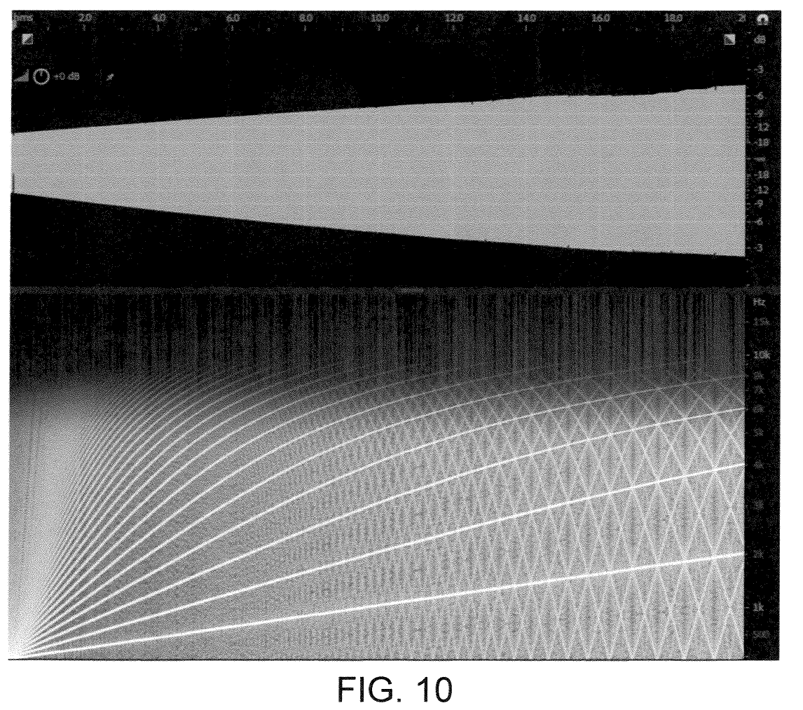

FIG. 10 shows an example of an engineered acoustic signal having a sawtooth waveform as a result of the present research.

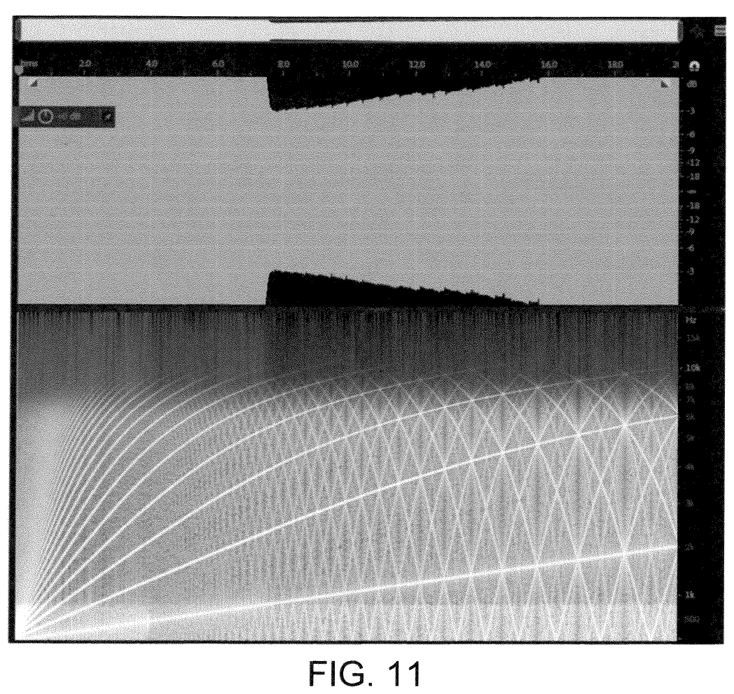

FIG. 11 shows an example of an engineered acoustic signal having a square waveform as a result of the present research.

Embodiments of the invention can be manifest in the form of methods and apparatuses for practicing those methods.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. An engineered acoustic signal for keeping an aquatic animal away from one or more specific areas, the engineered acoustic signal having deterrence stimulus evaluated to maximize effectiveness in keeping animals away from specific areas based on at least one of:
ability of the deterrence stimulus to initiate a behavioral response of the animal to keep the animal from the one or more specific areas;
duration of the behavioral response; and
magnitude of the behavioral response.

2. The engineered acoustic signal of claim 1, wherein evaluating the deterrence stimulus of the engineered acoustic signal to maximize effectiveness comprises
deploying the engineered acoustic signal in an aquatic environment to deter invasive carp; and
observing the behavioral response of the invasive carp which comprises experimentally observing presence or absence of at least one of the following response factors:
rapid onset of sound;
irregular patterns of sound;
sound that increases in amplitude of a frequency range;
sound that does not decrease in frequency or loudness;
sound that is greater than 140 dB re 1 μPa; and
sounds that overlap in upper end and lower end of the invasive carp's hearing which tend to create stronger behavioral responses of the invasive carp.

3. The engineered acoustic signal of claim 1, which is audible to a certain species of invasive carp.

4. The engineered acoustic signal of claim 1, which is masked by navigation noise, wherein evaluating the deterrence stimulus of the engineered acoustic signal to maximize effectiveness comprises:
determining an appropriate frequency range in which to increase the engineered acoustic signal so as to deter the animal despite a presence of the navigation noise.

5. The engineered acoustic signal of claim 1, having a Doppler like-effect of sound approaching the animal.

6. The engineered acoustic signal of claim 1, having the following characteristics:
(i) chirp sawtooth 20 Hz 2000 Hz 02a 08a Lin LP 5000 Hz, being based on a sawtooth waveform set at 20 HZ, 2000 Hz, Linear progress, Low Pass filter at 5000 Hz, and silenced over 7 kHz, with a peak amplitude of 70.8 dB Pa and total RMS amplitude of 58.6 dB Pa., or (ii) chirp sawtooth 20 Hz 2000 Hz 02a 08a Log LP 5000 Hz, being based on a sawtooth waveform set at 20 HZ, 2000 Hz, Logarithmic progress, Low Pass filter at 5000 Hz, and silenced over 7 kHz, with a peak amplitude of 72.3 dB Pa and total RMS amplitude of 59 dB Pa.;
a 3.36 MB uncompressed .wav file;
a mono signal that is 20 seconds long with a sample rate of 44100 Hz and a 32-bit float depth; and
a buffer zone of 5000-7000 Hz.

7. The engineered acoustic signal of claim 1, having the following characteristics:
(i) chirp sine 20 Hz 2000 Hz 02a 08a Lin LP 5000 Hz, being based on a sine waveform set at 20 HZ, 2000 Hz, Linear progress, Low Pass filter at 5000 Hz, and silenced over 7 kHz, or (ii) chirp sine 20 Hz 2000 Hz 02a 08a Log LP 5000 Hz, being based on a sine waveform set at 20 HZ, 2000 Hz, Logarithmic progress, Low Pass filter at 5000 Hz, and silenced over 7 kHz;
a 3.36 MB uncompressed .wav file;
a mono signal that is 20 seconds long with a sample rate of 44100 Hz and a 32-bit float depth;
a peak amplitude of 74.5 dB Pa and total RMS amplitude of 61.2 dB Pa; and
a buffer zone of 5000-7000 Hz.

8. The engineered acoustic signal of claim 1, having the following characteristics:
chirp square 20 Hz 2000 Hz 02a 08a Log LP 5000 Hz;
being based on a square waveform set at 20 HZ, 2000 Hz, Logarithmic progress, Low Pass filter at 5000 Hz, and silenced over 7 kHz;
a 3.36 MB uncompressed .wav file;
a mono signal that is 20 seconds long with a sample rate of 44100 Hz and a 32-bit float depth;
a peak amplitude of 77.7 dB Pa and total RMS amplitude of 63.9 dB Pa; and
a buffer zone of 5000-7000 Hz.

9. The engineered acoustic signal of claim 1, having the following characteristics:
(i) chirp square 20 Hz 4000 Hz 02a 08a Lin LP 6000 Hz, being based on a square waveform set at 20 HZ, 4000 Hz, Linear progress, Low Pass filter at 6000 Hz, and silenced over 7 kHz, with a peak amplitude of 84.7 dB Pa and total RMS amplitude of 69.5 dB Pa, or (ii) chirp square 20 Hz 2000 Hz 02a 08a Log LP 6000 Hz, being based on a square waveform set at 20 HZ, 2000 Hz, Logarithmic progress, Low Pass filter at 6000 Hz, silenced over 7 kHz, and aliasing removed, with a peak amplitude is 84.7 dB Pa and total RMS amplitude is 71.6 dB Pa;
a 3.36 MB uncompressed .wav file;
a mono signal that is 20 seconds long with a sample rate of 44100 Hz and a 32-bit float depth; and
a buffer zone of 6000-7000 Hz.

10. A method of deploying a designed deterrent acoustic array or engineered acoustic signal for keeping an aquatic animal away from one or more specific areas, the method comprising evaluating the designed deterrent acoustic array or engineered acoustic signal having deterrence stimulus to maximize effectiveness in keeping the aquatic animal away from specific areas based on at least one of:
ability of the deterrence stimulus to initiate a behavioral response of the animal to keep the animal from the one or more specific areas;
duration of the behavioral response; and
magnitude of the behavioral response.

11. The method of claim 10, wherein evaluating the deterrence stimulus of the designed deterrent acoustic array or engineered acoustic signal to maximize effectiveness comprises
deploying the deterrent acoustic array or engineered acoustic signal in an aquatic environment to deter invasive carp; and
observing the behavioral response of the invasive carp which comprises experimentally observing presence or absence of at least one of the following response factors:
rapid onset of sound;
irregular patterns of sound;
sound that increases in amplitude of a frequency range;
sound that does not decrease in frequency or loudness;
sound that is greater than 140 dB re 1 μPa; and
sounds that overlap in upper end and lower end of the invasive carp's hearing which tend to create stronger behavioral responses of the invasive carp.

12. The method of claim 10, further comprising:
deploying the deterrent acoustic array or engineered acoustic signal, which is audible to a certain species of invasive carp, in an aquatic environment to deter invasive carp.

13. The method of claim 10, wherein the designed deterrent acoustic array or engineered acoustic signal is in a presence of navigation noise, wherein evaluating the deterrence stimulus of the designed deterrent acoustic array or engineered acoustic signal to maximize effectiveness comprises:
determining an appropriate frequency range in which to increase the designed deterrent acoustic array or engineered acoustic signal so as to deter the animal despite being masked by the navigation noise.

14. The method of claim 10, further comprising producing a Doppler like-effect of sound approaching the animal using the designed deterrent acoustic array or engineered acoustic signal.

15. The method of claim 10, further comprising:
deploying the designed deterrent acoustic array in a Lock & Dam;
modifying the designed deterrent acoustic array which includes:
measuring an output of sound projector array elements of the designed deterrent acoustic array and interaction between the sound projector array elements;
measuring ambient levels of sound in an approach channel of the Lock & Dam;
measuring sound propagation in the approach channel of the Lock and Dam;
determining appropriate classes of one or more propagation models to use at the Lock & Dam; and
developing an acoustic propagation model for the approach channel of the Lock & Dam that best predicted the measured output, and the measured ambient levels, the sound propagation in the approach channel; and
redeploying the modified designed deterrent acoustic array in the Lock & Dam using the developed acoustic propagation model.

16. The method of claim 10, further comprising:
observing a quantitative measure of deterrence as a distance travelled of how far an invasive carp will continue to travel while maintaining a prior direction of travel before encountering the designed deterrent acoustic array or engineered acoustic signal, when subjected to the designed deterrent acoustic array or engineered acoustic signal; and
modifying the designed deterrent acoustic array or engineered acoustic signal until the distance travelled is 20,000 cm or less.

17. The method of claim 10, wherein the designed deterrent acoustic array or engineered acoustic signal has the following characteristics:
(i) chirp sawtooth 20 Hz 2000 Hz 02a 08a Lin LP 5000 Hz, being based on a sawtooth waveform set at 20 HZ, 2000 Hz, Linear progress, Low Pass filter at 5000 Hz, and silenced over 7 kHz, with a peak amplitude of 70.8 dB Pa and total RMS amplitude of 58.6 dB Pa., or (ii) chirp sawtooth 20 Hz 2000 Hz 02a 08a Log LP 5000 Hz, being based on a sawtooth waveform set at 20 HZ, 2000 Hz, Logarithmic progress, Low Pass filter at 5000 Hz, and silenced over 7 kHz, with a peak amplitude of 72.3 dB Pa and total RMS amplitude of 59 dB Pa.;
a 3.36 MB uncompressed .wav file;
a mono signal that is 20 seconds long with a sample rate of 44100 Hz and a 32-bit float depth; and
a buffer zone of 5000-7000 Hz.

18. The method of claim 10, wherein the designed deterrent acoustic array or engineered acoustic signal has the following characteristics:
(i) chirp sine 20 Hz 2000 Hz 02a 08a Lin LP 5000 Hz, being based on a sine waveform set at 20 HZ, 2000 Hz, Linear progress, Low Pass filter at 5000 Hz, and silenced over 7 kHz, or (ii) chirp sine 20 Hz 2000 Hz 02a 08a Log LP 5000 Hz, being based on a sine waveform set at 20 HZ, 2000 Hz, Logarithmic progress, Low Pass filter at 5000 Hz, and silenced over 7 kHz;
a 3.36 MB uncompressed .wav file;
a mono signal that is 20 seconds long with a sample rate of 44100 Hz and a 32-bit float depth;
a peak amplitude of 74.5 dB Pa and total RMS amplitude of 61.2 dB Pa; and
a buffer zone of 5000-7000 Hz.

19. The method of claim 10, wherein the designed deterrent acoustic array or engineered acoustic signal has the following characteristics:
chirp square 20 Hz 2000 Hz 02a 08a Log LP 5000 Hz;
being based on a square waveform set at 20 HZ, 2000 Hz, Logarithmic progress, Low Pass filter at 5000 Hz, and silenced over 7 kHz;
a 3.36 MB uncompressed .wav file;
a mono signal that is 20 seconds long with a sample rate of 44100 Hz and a 32-bit float depth;
a peak amplitude of 77.7 dB Pa and total RMS amplitude of 63.9 dB Pa; and
a buffer zone of 5000-7000 Hz.

20. The method of claim 10, wherein the designed deterrent acoustic array or engineered acoustic signal has the following characteristics:
(i) chirp square 20 Hz 4000 Hz 02a 08a Lin LP 6000 Hz, being based on a square waveform set at 20 HZ, 4000 Hz, Linear progress, Low Pass filter at 6000 Hz, and silenced over 7 kHz, with a peak amplitude of 84.7 dB Pa and total RMS amplitude of 69.5 dB Pa, or (ii) chirp square 20 Hz 2000 Hz 02a 08a Log LP 6000 Hz, being based on a square waveform set at 20 HZ, 2000 Hz, Logarithmic progress, Low Pass filter at 6000 Hz, silenced over 7 kHz, and aliasing removed with a peak amplitude is 84.7 dB Pa and total RMS amplitude is 71.6 dB Pa;
a 3.36 MB uncompressed .wav file;
a mono signal that is 20 seconds long with a sample rate of 44100 Hz and a 32-bit float depth; and
a buffer zone of 6000-7000 Hz.
